(19) United States
(12) Patent Application Publication
(10) Pub. No.: US 2026/0270232 A1
(43) Pub. Date: Sep. 10, 2026

(54) DYNAMIC SKILLS-BASED REGISTRATION AND ROUTING IN A NETWORK OF ARTIFICIAL INTELLIGENCE AGENTS VIA A DIRECTORY SYSTEM

(71) Applicant: Cisco Technology, Inc., San Jose, CA (US)

(72) Inventors: Eric A. Voit, Bethesda, MD (US); Samer M. Salam, Beirut (LB); Arjun Sambamoorthy, San Jose, CA (US)

(21) Appl. No.: 19/073,119

(22) Filed: Mar. 7, 2025

(51) Int. Cl. H04L 61/4511

(52) U.S. Cl. CPC H04L 61/4511

(57) ABSTRACT

An example embodiment provides a skills-based registration and routing mechanism across a federation of artificial intelligence (AI) agents based on semantic overlap in a vector space of requests and polytope boundaries representing agent capabilities. The routing mechanism enables each AI agent to register their set of capabilities represented as boundaries of a polytope in the vector space with a directory system (e.g., modified or extended Domain Name System (DNS) servers, etc.). A source agent receives a user request and queries the directory system to identify a remote target agent capable of handling the user request based on overlap of the request with advertised polytope boundaries (representing capabilities of remote target agents). The user request is forwarded from the source agent to the identified remote target agent based on a user intent expressed in the user request.

### TECHNICAL FIELD

The present disclosure relates to network routing.

### BACKGROUND

As enterprises embrace generative artificial intelligence (AI) to build virtual assistants (or agents), these assistants are specialized in their respective domains in order to offer guarantees on performance metrics, such as precision and reliability. This is accomplished through custom fine-tuned large language models (LLMs), using retrieval-augmented generation (RAG) mechanisms with the proper domain knowledge, or a combination thereof. In order to provide a cohesive customer experience, the specialized agents are interconnected over a fabric that handles request routing from a source agent that receives a user request to a target agent that has the necessary skills to service and answer that request. Each agent may offer its own native user interface, which is typically integrated into one or more of the enterprise products, and can process user queries meant for the agent itself or for agents interconnected over the fabric.

For example, multiple virtual assistants (or agents) may each be configured to cover a corresponding topic (e.g., security products, collaboration, networking, etc.). The agents are interconnected in a fabric that supports request routing to the proper agent that can service a user request or query regardless of which source agent interacts with the user. By way of example, a user may be using a networking agent, and has a query regarding firewall policies that needs to be serviced by a security agent.

An approach to route user requests to an appropriate agent is based on semantic similarity in a vector space. Predefined routing policies are registered by listing example utterances (or phrases) for a given routing policy. The degree of similarity of an embedding of the user query is compared to the example utterances for the various predefined routing policies in order to determine a best matching route.

However, the approach does not support routing based on a context absent in the user utterance. For example, an intent such as “which access-point has the highest client density in my network” may need to be routed to different agents depending on the particular product used at a customer site. Since the user phrase itself does not provide this context, request routing based on semantic analysis of phrases/utterances is insufficient.

### BRIEF DESCRIPTION OF THE DRAWINGS

FIG. 1 is a block diagram of an example network environment in which request routing may be implemented, according to an example embodiment.

FIG. 2 is a flowchart of a method for routing requests to corresponding agents, according to an example embodiment.

FIG. 3 is a flowchart of a method for determining agents by a source agent to process requests, according to an example embodiment.

FIG. 4 illustrates a packet with a modified Domain Name System (DNS) query message for semantic routing of requests, according to an example embodiment.

FIG. 5 is a flowchart of a method for determining agents by a directory system to process requests, according to an example embodiment.

FIG. 6 is a block diagram of a hierarchy of directory servers for determining agents, according to an example embodiment.

FIG. 7 illustrates a packet with a modified DNS response message for semantic routing of requests, according to an example embodiment.

FIG. 8A illustrates an example vector space for a source agent for determining agents to process requests, according to an example embodiment.

FIG. 8B illustrates an example vector space for a directory system for determining agents to process requests, according to an example embodiment.

FIG. 9 illustrates a flowchart of a generalized method for routing requests to corresponding agents, according to an example embodiment.

FIG. 10 illustrates a hardware block diagram of a computing device configured to perform functions associated with routing requests to corresponding agents as discussed herein, according to an example embodiment.

### DETAILED DESCRIPTION

### Overview

An example embodiment provides a skills-based registration and routing mechanism across a federation of artificial intelligence (AI) agents based on semantic overlap in a vector space of requests and polytope boundaries representing agent skills or capabilities. The polytope boundaries in the vector space are used for skills advertisement. The example embodiment routes requests over the federation of AI agents to corresponding AI agents capable of handling the requests. The routing mechanism enables each AI agent to register their set of skills or capabilities (e.g., the set of user intents and contexts that the AI agent is capable of handling) represented as boundaries of a polytope in the vector space with a directory system (e.g., modified or extended Domain Name System (DNS) servers, etc.). A source agent receives a user request and queries the directory system to identify a remote target agent capable of handling the user request based on overlap of the request with advertised polytope boundaries (representing skills or capabilities of the remote target agents). The user request is forwarded from the source agent to the identified remote target agent based on a user intent expressed in the user request.

### Example Embodiments

An example embodiment determines a remote AI agent as a destination for routing of a request or question received by a source AI agent within a network of AI agents. This may be performed within a highly scalable modified or extended Domain Name System (DNS) or other directory infrastructure which redirects requests or questions to various authoritative sources based on the underlying meaning of the question. Authoritative ownership of various types of meaning is asserted by remote AI agents in the form of ranges of quantized embeddings (representing a polytope in a semantic vector space). Each range indicates coverage of a knowledge domain, skill, capability, and/or intent of an AI agent. A user enters a text question within a local AI agent, and embeddings for sentences are generated. When the question is outside the scope of the source agent (based on a comparison of embeddings of the question and embedding ranges for the source agent and known peer agents), the sentence embedding is sent to a modified or extended DNS server. The modified DNS server checks the sentence embedding to determine whether the sentence embedding falls with ranges of quantized embeddings supported by a remote AI agent (indicating the remote AI agent has sufficient skills or capabilities to handle the question). The modified DNS server returns the IP address of the remote AI agent that can answer the question. The example embodiments are not limited to utilizing DNS-based systems, and may employ any directory systems (e.g., Lightweight Directory Access Protocol (LDAP), etc.) adapted for semantic routing in substantially the same manner described herein.

An example embodiment provides a DNS-based approach for distributing questions across a mesh of AI agents. A modified or extended DNS protocol enables support of massive scale, distributed ownership of domains and sub-domains, and support of quick changes to topology via time to live and dynamic DNS. AI agents populate the modified DNS infrastructure with skills/capabilities/intents by defining a polytope per intent (within a semantic vector space). The polytope boundaries are determined based on a list of sample question embeddings that may be derived using any conventional or other tools (e.g., GLOVE, WORD2VEC, SBERT, etc.). An embedding of a question that is received by the modified DNS infrastructure from a source AI agent and resides within the boundaries of a polytope of a remote AI agent is deemed answerable. The result provided by the modified DNS infrastructure includes the IP address of that remote AI agent and the matching polytope, and is cached in the source AI agent. Question embeddings outside the polytope ranges within the modified DNS infrastructure produce a result indicating an absence of a remote AI agent with sufficient skills or capabilities to handle the question. The example embodiment provides a scalable approach for routing questions to the proper AI agent based on the underlying semantic meaning of the question.

An example embodiment provides a dynamic mechanism for skills registration that may be used for semantic routing of requests in a network of AI agents. Each AI agent registers their skills or capabilities (e.g., a set of user intents and contexts that the AI agent is capable of handling, etc.) with a directory system (e.g., modified or extended Domain Name System (DNS) server, etc.). The set of skills or capabilities for each agent is indicated by boundaries of a polytope in a semantic vector space corresponding to the skills or capabilities of the agent. An initial agent receiving a user request queries the directory system for a remote agent. The directory system identifies the remote agent based on overlap of the request with registered polytope boundaries (representing skills or capabilities of the remote agents). The initial agent routes the user request to an appropriate remote agent identified by the directory system for processing based on the skills or capabilities of the remote agent corresponding to a user intent (or requested functionality) in the request.

In an example embodiment, AI agents advertise a semantic domain of requests or questions for which they are capable of providing an answer via a polytope construct (in a semantic vector space). A semantic meaning being served by a federated AI agent is advertised to a set of other federated AI agents to provide request routing across the federated set of AI agents.

An example embodiment enables large federations of AI agents to be established, and provides a manner for how requests or questions can be optimally semantically routed between the AI agents. These federations enable a local AI agent to access a larger variety of back-end remote AI agents when the local AI agent cannot answer a request. The example embodiment further enables an AI agent to summarize multi-dimensional semantic surfaces so as to hide the specifics of individual AI agents (e.g., similar to a proxy gateway, etc.). Accordingly, complex assemblies of various AI agents can be assembled behind any specific local AI agent, where the local AI agent determines the set of questions the local AI agent can semantically answer, forward, proxy, or assert an inability to answer.

In order to provide a cohesive customer experience, an example embodiment provides a federation of specialized AI agents within a network and handles request routing from a source agent that receives a user request to a remote agent that has the necessary skills to service and answer that request. A mechanism may be implemented where each AI agent provides its own native user interface, which is typically integrated into one or more enterprise products, and can handle user queries meant for the agent itself or for remote agents. For example, multiple AI agents may cover security products, collaboration, and networking. In order to offer customers a uniform experience across all of these agents, a federation of AI agents supports request routing to a proper AI agent that can service a customer request or query regardless of which source agent interacts with the user (e.g., the user may be using the networking agent, and has a query regarding firewall policies that needs to be serviced by a security agent).

An example embodiment provides a routing mechanism to support request routing over a federation of AI agents. The routing mechanism enables each agent to register the set of skills or capabilities (e.g., the set of user intents and contexts that the agent is capable of handling) with a directory system (e.g., modified or extended DNS servers, etc.). A source agent receives a user request and queries the directory system to identify a remote agent capable of handling the user request. The source agent forwards the user request to the remote agent identified by the directory system based on the user intent expressed in the user request.

An example embodiment queries a directory system (e.g., modified or extended DNS servers, etc.) by sending an encoded request or question to be processed. The directory system identifies a best matching destination IP address of an AI agent to handle the request based on an overlap between the encoded request and polytope boundaries of the AI agents within a semantic vector space representing skills or capabilities of the AI agents (instead of, or in addition to, resolving a URL into a destination IP address as is performed in conventional DNS). A modified packet structure is utilized for queries and responses of the directory system to determine the AI agent. The directory system continuously maintains all the supported AI agent intents numerically (via polytope boundaries), and responses from the directory system are provided when the encoded question falls within dimensional ranges of a polytope of an intent of at least one AI agent. The values indicating the boundaries of a polytope associated with a remote AI agent may be exposed as part of a schema of a centrally maintained directory system (e.g., modified or extended DNS (or dynamic DNS) servers, etc.). Modified DNS protocols and constructs allow the specific polytope values to be in-flux and hidden without compromising the scale of the directory system.

In an example embodiment, any AI agent may define a semantic domain for which the AI agent can answer questions. This is represented by a local polytope (in a semantic vector space) and provided to the directory system (e.g., modified or extended DNS servers, etc.). A request or question received by the directory system and residing within the semantic scope of a polytope of an AI agent is deemed answerable, and the identity of that AI agent is returned along with the polytope evidence showing question support. Requests or questions outside an aggregation of polytope ranges within the directory systems are indicated as lacking a matching AI agent in a result. This provides a manner to assert one or more remote AI agents that can help answer questions.

In an example embodiment, the directory system (e.g., modified or extended DNS servers, etc.) may include a hierarchical structure (e.g., similar to a hierarchical structure of domains and sub-domains in conventional DNS). AI agents registered or associated with servers at higher levels have greater ranges for boundaries of regions (e.g., combined regions of child agents, broader skill set, etc.) corresponding to broader skills or capabilities, while AI agents registered or associated with servers at lower levels have lesser ranges for bounds of polytopes corresponding to specialized skills or capabilities. The directory system may provide results indicating AI agents with broader or specialized skills based on the request and/or other parameters. For example, the directory system may traverse the hierarchical structure to identify the lowest level (most specialized) agent corresponding to a polytope encompassing the request. The directory system may desire to hide or restrict access to lower level agents and provide the higher level agents to handle the request.

An example embodiment may employ multiple directory systems (e.g., with modified or extended DNS servers, etc.), each specializing in a type of request or question set for which that directory system can provide guidance (e.g., a directory system can assert its own semantic space). Further, a private directory system (e.g., modified or extended DNS servers, etc.) may be employed which advertises sets of requests or questions which the private directory system can answer (e.g., the services do not have to be accessible to all, etc.). This provides an ability to bid a question across a mix of public and private directory systems. Moreover, a directory system may be selected based on load balancing to provide queries to less loaded directory systems. In addition, multiple answers may be provided for a directory system query based on a most explicit match to the meaning (e.g., question falls in the smallest ranges between low value, high value pairs), reputation of the AI agent in actually answering the question, and/or monetary costs to answer questions returned by the directory system.

In an example embodiment, a modified dynamic DNS (DDNS) may be used for the semantic routing. DDNS enables automatic updates to DNS for IP addresses. For example, encoded requests or questions served by a particular AI agent (represented as polytope boundaries) may be stored into the modified DNS (and mapped to the IP address of the AI agent). When a user text query is received and applied against the modified DNS, the user query is encoded and matched against the stored questions and corresponding AI agents (e.g., similar to a lookup in VectorDB). This enables the AI agent identity/IP address to be returned corresponding to the most similar example to the user query.

In an example embodiment, the semantic routing may be latched. For example, when the remote AI agent drives an interactive dialogue with a user, the source agent needs to continue forwarding user utterances to the same remote AI agent until the source agent receives an indication from the remote AI agent that the dialog completed. A lock/release mechanism between the source and remote AI agents is used to determine when a particular semantic routing interaction should be released back to the source AI agent (for routing of requests to other remote AI agents).

It will be appreciated that the techniques of example embodiments may be performed for routing of any types of requests or queries (e.g., for any desired information or actions) to any types of artificial intelligence (AI) or other agents capable of processing the requests. Further, the present embodiments may be applied to any structure, framework, and/or network of agents coupled in any fashion. The skills or capabilities of an agent may be based on any attributes pertaining to the types of requests that may be processed by the agent (e.g., products, topics, actions, set of commands, intents, contexts (e.g., network or other environment attributes, etc.), etc.). An intent of an agent may include any natural language or other description of a purpose (or functionality) of the agent. An intent of a request may include any natural language or other description of a purpose (or requested functionality) for the request, while the context may include any attributes pertaining to the request (e.g., item, topic, network or other environment attributes, etc.). In addition, the example embodiments may employ any type of directory systems (e.g., DNS, Lightweight Directory Access Protocol (LDAP), etc.) modified or adapted to identify any quantity of agents to handle a request in substantially the same manner described below.

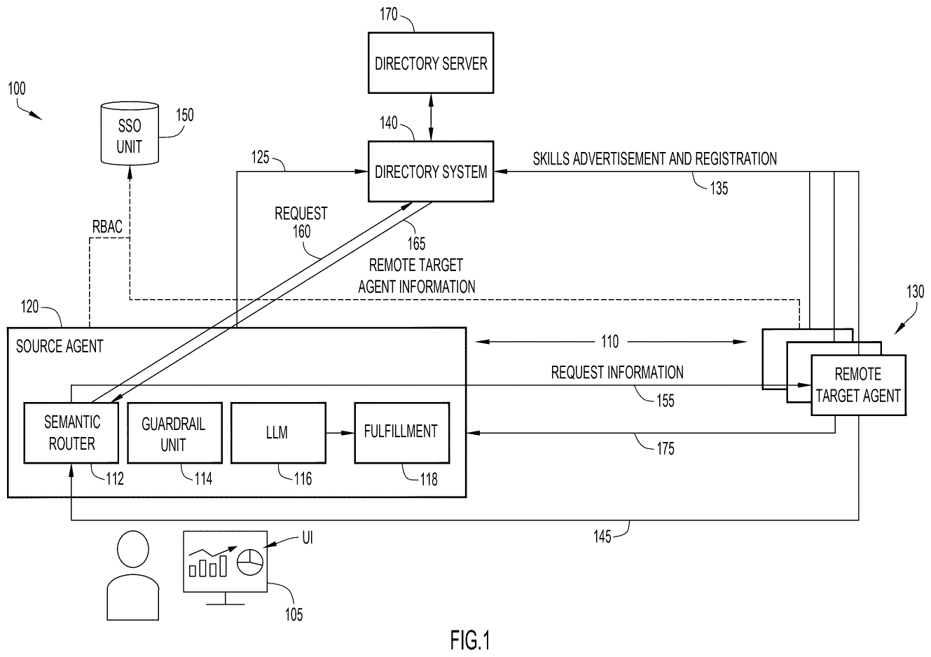

FIG. 1 illustrates an example network environment 100 in which an embodiment presented herein may be implemented. Network environment 100 includes a plurality of agents 110, one or more directory systems 140, and a single sign-on (SSO) unit 150. Each agent 110 includes skills or capabilities to process certain requests or queries (e.g., certain topics, products, actions, set of commands, etc.). By way of example, network environment 100 may be employed for a call or support center to provide responses to requests or queries for information for items (e.g., products, services, etc.). However, the network environment may be employed for various scenarios. The request preferably includes text (or audio converted to text), while the response may include text (or audio converted from text), figures, diagrams, tables, and/or other visual elements.

The skills or capabilities of agents 110 are dynamically registered with directory system 140 to enable the directory system to determine the appropriate agents for processing requests (from initial agents receiving the requests). In other words, directory system 140 determines one or more agents 110 with sufficient skills or capabilities to process a request. The initial agents are provided with information for the agents determined by the directory system in order to route the requests to those determined agents. Alternatively, directory system 140 may route the requests to the determined agents.

Directory system 140 may include one or more directory servers 170, each specializing in a type of request or question set for which that directory server can provide guidance (e.g., the modified DNS server can assert its own semantic space). By way of example, directory servers 170 may include DNS-based servers (e.g., modified or extended DNS servers, etc.). The DNS-based server may include any server or other computing device employing a DNS-based protocol, such as a DNS protocol modified as described below) to determine appropriate remote agents to handle a request (instead of, or in addition to, resolving URLs to IP addresses). Further, private directory systems (e.g., private, modified DNS servers, etc.) may be employed which advertise sets of requests or questions which the private directory system can answer (e.g., the services do not have to be accessible to all, etc.). This provides an ability to bid a question across a mix of public and private directory systems. Moreover, a query may be provided to directory systems based on load balancing in order to provide queries to less loaded directory systems. In addition, multiple answers may be provided for a directory system query based on a most explicit match to the meaning (e.g., question falls in the smallest ranges between low value, high value pairs of polytope boundary dimensions, etc.), reputation of the AI agent in actually answering the question, and/or monetary costs to answer questions returned by the directory system.

In an example embodiment, directory system 140 may include a hierarchical structure of directory servers 170 (and corresponding AI agents) (e.g., similar to a hierarchical structure of domains and sub-domains in conventional DNS). AI agents registered or associated with directory servers of higher levels have greater ranges for boundaries of polytopes in a semantic vector space representing agent skills or capabilities (e.g., combined regions of child agents, broader skill set, etc.) and corresponding to broader skills or capabilities, while AI agents registered or associated with directory servers of lower levels have lesser ranges for bounds of polytopes corresponding to specialized skills or capabilities. Directory system 140 may provide results indicating AI agents with broader or specialized skills based on the request and/or other parameters. For example, directory system 140 may traverse the hierarchical structure to identify the lowest level (most specialized) agent corresponding to a polytope encompassing the request. The directory system may desire to hide or restrict access to lower level agents and provide the higher level agents to handle the request.

In addition, the skills or capabilities of certain agents (e.g., handling high volume requests or use cases) may be dynamically registered with other agents 110 for direct routing of requests (without directory system 140) to those other agents. The routing information for the certain agents may be stored in a cache for rapid access and routing. The registration is dynamic and may be updated (or performed) as skills or capabilities of agents 110 change and/or new agents 110 are added to network environment 100. Single sign-on unit 150 provides any conventional or other security that enables access of the network environment and other platforms by a user using a single set of login or other credentials. The security may further provide any conventional or other roles based access control (RBAC, as viewed in FIG. 1) that controls system access for users based on user roles and locations.

Agents 110 may include a source agent 120 that receives a request from an end-user device 105 of a user, and one or more remote target agents 130 with skills or capabilities to process certain requests or queries (e.g., certain topics, products, actions, set of commands, etc.). Any agents 110 may serve as a source agent 120 and/or remote target agent 130 to receive and process requests. Source agent 120 provides a user interface (for end-user device 105) to receive requests and provide results for the request. The request preferably includes text (or audio converted to text), while the results preferably include text (or audio converted from text). Further, source agent 120 verifies the user (e.g., via SSO unit 150), and analyzes the request for routing decisions (e.g., routing to a directory system 140 and/or appropriate agents 110 (e.g., source agent 120 and/or remote target agents 130) with sufficient skills or capabilities to process the request). End-user device 105, source agent 120, remote target agents 130, directory systems 140, and SSO unit 150 may be local to each other and/or communicate over a communication network that may include one or more wide area networks (WANs), such as the Internet, and one or more local area networks (LANs). These components may communicate with each other over the communication network using a variety of known or hereafter developed communication protocols.

Source agent 120 includes a semantic router 112, a guardrail unit 114, and an LLM 116. Remote target agents 130 may be substantially similar to source agent 120 and include these components. Semantic router 112 analyzes a request for routing according to example embodiments as described below. Guardrail unit 114 may monitor the request and results from LLM 116 for malicious queries, queries outside the terms of service, and/or hallucinations (or incorrect or irregular results) from LLM 116 and perform remedial actions (e.g., discard an improper request or irregular results, etc.) via any conventional or other techniques.

LLM 116 processes a request and produces results or fulfillment 118 when source agent 120 has sufficient skills or capabilities to process the request. By way of example, LLM 116 may employ any conventional or other large language model (LLM) and natural language processing (NLP) techniques to process the request and provide requested information and/or perform actions. These techniques can parse and understand text, and extract various elements, data types, tasks, and other relevant information. This information can be used to produce results for the request. The LLM may receive a prompt or natural language instruction, and process the prompt to determine the actions to be performed to produce the results. The prompt may include several variations and forms.

However, any quantity of any conventional or other machine learning and/or natural language processing (NLP) models may be used (e.g., mathematical/statistical models, classifiers, feed-forward (fully or partially connected), recurrent (RNN), convolutional (CNN), or other neural networks, deep learning models, long short-term memory (LSTM), attention-based methods/transformers, large language model (LLM), entity extraction, relationship extraction, part-of-speech (POS) taggers, semantic analysis, etc.) that are configured to provide the corresponding skills or capabilities for handling certain requests associated with an agent 110 (e.g., certain topics, products, actions, set of commands, etc.).

For example, neural networks may include an input layer, one or more intermediate layers (e.g., including any hidden layers), and an output layer. Each layer includes one or more neurons, where the input layer neurons receive input (e.g., text or text features, etc.), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the machine learning of the neural network may be performed using a training set of various text (e.g., request/query, etc.) as input and corresponding desired outputs (e.g., results for requests or queries, actions to perform to retrieve results for requests or queries, etc.), where the neural network attempts to produce the provided output and uses an error from the output (e.g., difference between produced and known outputs) to adjust weight (and bias) values (e.g., via backpropagation or other training techniques).

The output layer neurons may indicate a probability for the input data being associated with a corresponding output (e.g., results for requests or queries, actions to perform to retrieve results for requests or queries, etc.). The output with the highest probability may be selected as the result.

Source agent 120 registers its skills or capabilities with directory system 140 (and one or more directory servers 170) at flow 125, while remote target agents 130 register their skills or capabilities with directory system 140 (and one or more directory servers 170) at flow 135. In addition, certain remote target agents 130 (e.g., handling high volume requests or use cases, etc.) may register their skills or capabilities with source agent 120 at flow 145. Remote target agents 130 may register their skills or capabilities directly with source agent 120 (e.g., for data privacy, etc.) or through directory system 140. The high volume use cases may be determined based on a quantity of cases (or specific types of requests) processed by source or remote target agents 120, 130 satisfying a threshold.

Source agent 120 may receive a request from end-user device 105. Semantic router 112 of source agent 120 analyzes the request to render routing decisions. For example, semantic router 112 may determine that source agent 120 has sufficient skills or capabilities to process the request. In this case, the request is processed by LLM 116 of source agent 120, and the results are returned to end-user device 105.

When semantic router 112 of source agent 120 determines that one or more remote target agents 130 registered with source agent 120 have sufficient skills or capabilities to process the request, semantic router 112 directly routes the request from source agent 120 to the determined remote target agents for processing at flow 155. The determined remote target agents process the request (e.g., via their corresponding LLMs 116 in substantially the same manner described above) and return results to source agent 120 at flow 175. The source agent combines the results from the remote target agents and provides an overall result to end-user device 105.

When semantic router 112 of source agent 120 determines that neither source agent 120 nor remote target agents 130 registered with source agent 120 have sufficient skills or capabilities to process the request, semantic router 112 of source agent 120 routes the request (or embedding of the request) to a directory system 140 at flow 160. Since directory system 140 preferably has registrations for all or a substantial portion of remote target agents 130 (or a greater quantity of remote target agents 130 than source agent 120), directory system 140 determines remote target agents 130 having sufficient skills or capabilities to process the request. The directory system provides information for the determined remote target agents (e.g., IP or other network address, agent identity, corresponding polytope boundaries representing skills or capabilities of the remote target agent, etc.) to source agent 120 at flow 165. The source agent forwards the request to the determined remote target agents at flow 155. Alternatively, the directory system (or directory servers 170) may route the request to the determined remote target agents.

The determined remote target agents process the request (e.g., via their corresponding LLMs 116 in substantially the same manner described above) and return results to source agent 120 at flow 175. Alternatively, the remote target agent may provide the response to directory system 140 for forwarding to the source agent, when directory system 140 routes the request. The source agent combines the results and provides an overall result to end-user device 105.

For example, an actual user request or question may be received by source agent 120. The source agent lacks sufficient confidence to answer a specific question locally, or has attempted to answer the question but metrics suggest the answer is sub-optimal. In this case, the question is tagged to be passed by source agent 120 to a directory system 140 (e.g., having skills or capabilities of remote target agents 130 registered with the directory system and represented by polytope boundaries in a semantic vector space). Directory system 140 determines the best fit polytope(s) corresponding to one or more alternative remote target agents 130 better suited to answer the question. After a response is returned back from directory system 140, the response is processed by source agent 120 in various manners before routing the request to a remote target agent. By way of example, source agent 120 may consider an assessment of the identity of the remote target agent (e.g., trustworthiness of the remote target agent asserting semantic knowledge of a semantic space), and/or assessments of a level of confidence in asserted semantic knowledge of the remote target agent. This confidence can be determined from the source and/or remote target agent, and can include the cost per query of an answer which might be provided by a remote target agent.

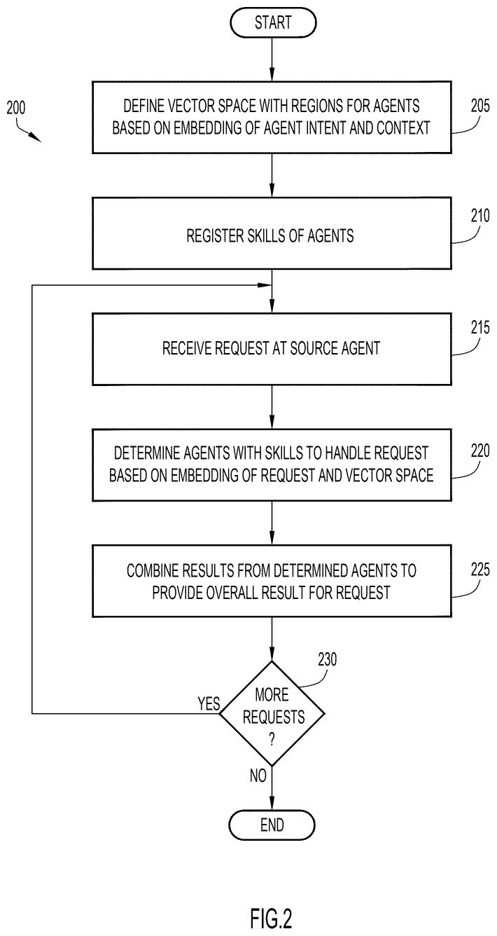

With continued reference to FIG. 1, FIG. 2 illustrates a flowchart of a method 200 for routing requests to corresponding agents, according to an example embodiment. Initially, a vector or multidimensional space is defined based on embeddings of intent and context for each of agents 110 (e.g., (intent, context)-tuples) at operation 205. The intent and context indicate skills or capabilities of an agent 110. Basically, each word or phrase (or tuple) may be represented by a vector (or embedding) having numeric elements corresponding to a plurality of dimensions (of the vector space). Words (or phrases or tuples with) similar meanings have similar word embeddings or vector representations. The word embeddings are produced from machine learning techniques or models (e.g., neural network as described above, etc.) based on an analysis of word usage in a collection of text or documents. The embeddings or vector representations may be pre-existing, and/or produced using any conventional or other tools or techniques (e.g., GLOVE, WORD2VEC, SBERT, etc.).

The dimensions of the embeddings correspond to dimensions of the vector space to map the embeddings to the vector space. In other words, an embedding may serve as coordinates in the vector space to identify a location in the vector space for the embedding (e.g., intent and context, etc.). The collective (intent, context) embeddings of each agent 110 occupy a corresponding discrete region in the vector space. The region may include two or more dimensions. By way of example, the region includes a convex polytope (e.g., n-dimensional generalization of a convex polygon within that n-dimensional space). In an example embodiment, the polytopes can be n-dimensional hypercubes. In other words, each region defines the entire set of skills or capabilities (e.g., intents, contexts, etc.) for a corresponding agent 110 and, thus, represents the boundary of the agent skills or capabilities. The regions of agents 110 may overlap which enables user requests to be multicast to, and processed by, more than one agent 110 as described below.

For example, an agent 110 can have each supported intent and context (e.g., skill or capability) indicated by a vector (or embedding) of ranges defined by minimum and maximum values for each dimension (e.g., based on different terminology or expressions for the intent and context, etc.). By way of example, a vector of n dimensions may be expressed as: {[dimension 1 (minimum value, maximum value)], [dimension 2 (minimum value, maximum value)], . . . [dimension n (minimum value, maximum value]}.

The totality of requests or queries which can be answered by a specific agent 110 may be represented as a set of these vectors (which define the boundaries of the region for the agent in the multidimensional or vector space). The set of vectors enables determination of whether a request or query is within the purview of skills or capabilities of a specific agent. By way of example, a request may be encoded as a single n-dimensional request vector (or embedding) in substantially the same manner described above. The request vector may be expressed as: {[dimension1], [dimension 2], . . . , [dimension n]}. The determination may be accomplished by numerical comparisons which check whether the dimensions of the request vector are within the dimension ranges (of the set of vectors) for the intents and contexts supported by an agent.

The skills or capabilities of an agent 110 may be based on any attributes pertaining to the types of requests that may be processed by the agent (e.g., products, topics, actions, set of commands, intents, contexts (e.g., network or other environment attributes, etc.), etc.). An intent of an agent 110 may include any natural language or other description of a purpose (or functionality) of the agent. By way of example, the skills or capabilities (e.g., intent and context, etc.) for an agent 110 may include client IP address pools for each managed virtual routing and forwarding (VRF) for a network macro-segment, network device IP address pools (e.g., for NetOps device management), geographic segmentation (e.g., an area under responsibility of a network controller), various tenants supported within a network controller datastore, different services maintained for service level agreements (SLAs) (e.g., level 2 VPN (L2VPN), level 3 VPN (L3VPN), etc.), and/or namespace division (e.g., context of managed objects under a network controller). Embeddings for one or more of these intents and contexts for an agent 110 may be generated to determine the region in the vector space indicating the boundary of skills or capabilities for the agent.

Agents 110 dynamically register their skills or capabilities with other agents and/or a corresponding directory system 140 (e.g., one or more directory servers 170, etc.) at operation 210. Remote target agents 130 may register with source agent 120 for high volume use cases. Remote target agents 130 may register their skills or capabilities directly with source agent 120 (e.g., for data privacy, etc.) or through directory system 140. The high volume use cases may be determined based on a quantity of cases (or specific types of requests) processed by source or remote target agents 120, 130 satisfying a threshold. The high volume use cases may be supported differently based on an identity of the source agent receiving the registration. This effectively enables custom behavior from a remote target agent 130 on answers to specific types of requests or queries based on the source agent 120 providing the query. Registration may be accomplished by an agent 110 providing bounds of the corresponding region or polytope in the vector space (defining the agent skills or capabilities) to another agent and/or directory system 140. The bounds may be represented by the set of vectors described above or by any quantity of any types of coordinate values in the vector space to indicate the boundaries of the region. Agents 110 and/or directory system 140 receiving the registration update their registration and routing information accordingly.

A user request from an end-user device 105 is received at a source agent 120 at operation 215. Semantic router 112 of source agent 120 analyzes the request to render routing decisions for determining agents (e.g., source agent 120 and remote target agents 130) with sufficient skills or capabilities to process the request at operation 220. For example, semantic router 112 of source agent 120 determines an embedding of the request (e.g., embedding of intent (or desired functionality) and context within the request), and identifies potential regions within a vector space for the source agent and/or remote target agents 130 registered with the source agent that encompass the embedding of the request. The intent and context of the request may be determined using any conventional or other natural language processing (NLP) techniques. When the region of source agent 120 is identified, the source agent may process the request (e.g., via LLM 116) to produce results. In other words, if the coordinates of the vector representing the embedding of the user request fall or reside within the region of the source agent, then the source agent may process the request. When one or more regions of remote target agents 130 registered with source agent 120 are identified, source agent 120 directly routes or sends the request to the remote target agents associated with the one or more identified regions to process the request (e.g., via corresponding LLMs 116 of the remote target agents). In other words, if the coordinates of the vector representing the embedding of the user request fall or reside within the regions of one or more remote target agents, then the one or more remote target agents may process the request. The results of the request from remote target agents 130 are returned to source agent 120. However, source agent 120 may employ various conventional or other techniques to determine the best/proper embedding vector match between the request embedding and the source agent or registered remote agent polytopes (e.g., the request embedding residing within all polytope ranges, a VectorDB or other search, cosine similarity, principal component analysis to determine which dimensions are relevant for comparison, etc.) in substantially the same manner described below.

In the event that the embedding of the request resides outside the regions of source agent 120 and the remote target agents 130 registered with the source agent (e.g., source agent 120 is unable to identify a region or agent), the request is routed or sent by source agent 120 to a directory system 140. Since directory system 140 preferably has registrations for all or a substantial portion of remote target agents 130 (or a quantity of remote target agents 130 greater than source agent 120), directory system 140 identifies the one or more regions in the vector space for the remote target agents encompassing the embedding of the request. When no regions can be identified (e.g., no regions encompass the embedding of the request), a closest or nearest region may be identified as described below.

Directory system 140 provides information for the remote target agents associated with the one or more identified regions (e.g., IP or other network address, agent identity, corresponding region or polytope, etc.) to source agent 120. The source agent routes or sends the request to the remote target agents 130 based on the information from directory system 140 to process the request (e.g., via corresponding LLMs 116 of the remote target agents). Alternatively, directory system 140 may route the requests to the remote target agents associated with the one or more identified regions.

The results of the request are returned from remote target agents 130 to source agent 120. Alternatively, the remote target agents may provide the response to directory system 140 for forwarding to source agent 120, when directory system 140 routes the request.

The above technique allows a cut-through mode from source agent 120 directly to remote target agents 130 for high volume requests, while maintaining directory system 140 as a default gateway for routing requests to remote target agents 130 whose skills or capabilities are not known to source agent 120.

The results from the identified agents (or directory system 140) are combined by source agent 120 to produce an overall result at operation 225 that is provided to end-user device 105 in response to the request. The above process is repeated from operation 215 for additional requests until the requests have been processed as determined at operation 230.

In an example embodiment, directory system 140 may employ a modified dynamic DNS (DDNS) for the semantic routing. DDNS enables automatic updates to DNS for IP addresses. For example, encoded requests or questions served by a particular remote target agent (represented as polytope boundaries) may be stored into the modified DNS (and mapped to the IP address of the remote target agent). When a user text query is received and applied against the modified DNS, the user query is encoded and matched against the stored questions and corresponding remote target agents (e.g., using distance or cosine similarity between embeddings of the user query and stored questions, etc.). This enables identification of the remote target agent corresponding to the most similar example to the user query and capable of answering the user query. The identity/IP address of the identified remote target agent is returned by the modified DNS for routing of the user query from the source agent to the identified remote target agent.

Further, an example embodiment may provide a text (non-encoded) request or question to directory system 140. In this case, primary and secondary directory servers 170 (e.g., modified DNS servers, etc.) coordinate on semantic meaning ranges via a notify mechanism (e.g., DNS NOTIFY, etc.).

In an example embodiment, the semantic routing may be latched. For example, when a remote target agent 130 drives an interactive dialogue with a user, source agent 120 needs to continue forwarding user utterances to the same remote target agent 130 until source agent 120 receives an indication from the remote target agent that the dialog completed. A lock/release mechanism between the source and remote target agents is used (e.g., flag, parameter value, semaphore, etc.) to determine when a particular semantic routing interaction should be released back to the source agent (e.g., for routing requests to other remote target agents, etc.).

An example embodiment may include a default directory system (e.g., a modified root DNS server, etc.) of last resort where out-of-scope requests or questions are forwarded. The question embedding (or the text question) may be sent from source agent 120 via a query (e.g., Root Name Server Query, etc.) when a local cache miss occurs for the semantic meaning of the question with respect to a polytope. Accordingly, continuous replication of questions/meanings need not be maintained until a question is asked. Further, employing a name server query (e.g., Authoritative Name Server Query, etc.) enables the default directory system to reply with another directory system that can redirect the request or question to the accepted authority for the semantic meaning. This allows full distribution of authority for questions in a way which is similar to the scaling mechanisms in DNS, and may be implemented without any new/changed fields in a DNS response.

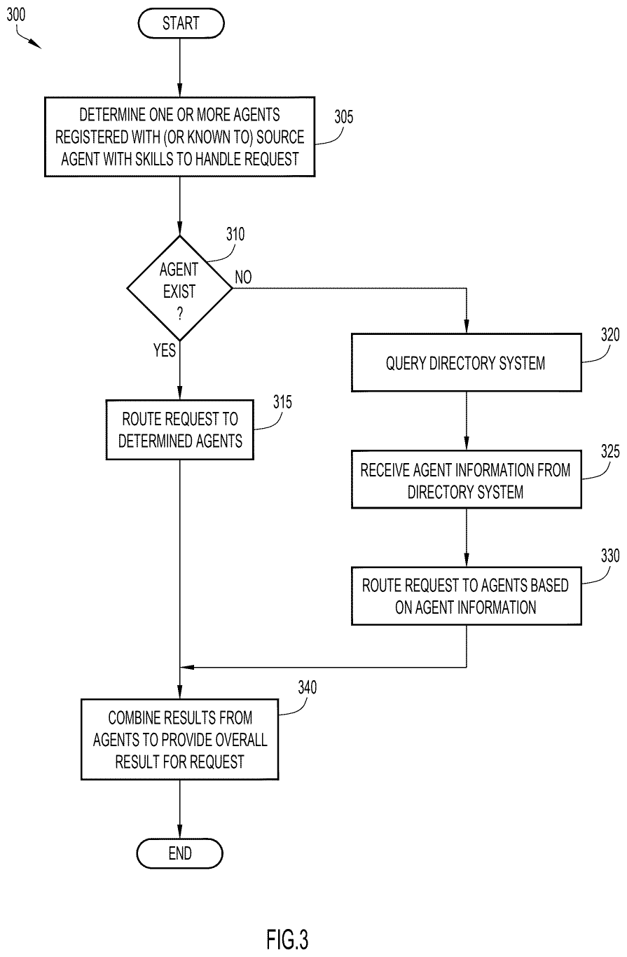

With continued reference to FIGS. 1 and 2, FIG. 3 illustrates a flowchart of a method 300 for determining agents by a source agent to process requests, according to an example embodiment. This may correspond to operations 220 and 225 of FIG. 2. Initially, a vector or multidimensional space is defined based on embeddings of intent and context for each of agents 110 (e.g., (intent, context)-tuples) in substantially the same manner described above. The collective (intent, context) embeddings of each agent 110 occupy a corresponding discrete region in the vector space. In other words, each region defines the entire set of skills or capabilities (e.g., intents, contexts, etc.) for a corresponding agent 110 and, thus, represents the boundary of the agent skills or capabilities in substantially the same manner described above. Agents 110 dynamically register their skills or capabilities with other agents and/or a corresponding directory system 140 in substantially the same manner described above (e.g., an agent 110 providing bounds of the corresponding region in the vector space to another agent and/or directory system 140).

A user request from an end-user device 105 is received at a source agent 120, and semantic router 112 of source agent 120 analyzes the request to determine one or more agents (e.g., source agent 120 and remote target agents 130), registered with or known to the source agent, with sufficient skills or capabilities to process the request at operation 305. For example, semantic router 112 of source agent 120 determines an embedding of the request (intent and context) mapped to the vector space, and identifies potential regions within the vector space for the source agent and/or remote target agents 130 registered with the source agent that encompass or contain the embedding of the request. This may be accomplished by comparing the request embedding (corresponding to coordinates in the vector space) to boundaries of the regions (corresponding to source and remote target agents) provided during registration and/or known to the source agent in substantially the same manner described above.

In addition, there may be scenarios where the request embedding is contained within more than one region due to overlapping. In this case, a selection technique may be employed to identify an appropriate region and corresponding source agent 120 and/or remote target agent 130. For example, each of agents 120, 130 associated with the regions containing the request embedding may be selected (e.g., the request may be routed or sent (multicast) to each of those agents). Further, the region having the closest or most explicit match may be selected. This may be determined based on any conventional or other distances of the request embedding to portions of the region (e.g., a request embedding having a greater distance from region boundaries or closer to a region center may represent a closer match, etc.). Moreover, overlapping region segments may be trimmed to resolve ambiguity (or remove the overlap) prior to receipt of the request (e.g., the region with less overlap may be trimmed, etc.).

When at least one agent exists (e.g., at least one region is identified, etc.) as determined at operation 310, semantic router 112 of source agent 120 provides the request to the agents corresponding to the identified regions at operation 315. For example, when the region of source agent 120 is identified, the source agent may process the request (e.g., via LLM 116 of source agent 120) to produce results. In the event, one or more regions of remote target agents 130 registered with source agent 120 are identified, semantic router 112 of source agent 120 directly routes or sends the request to the remote target agents associated with the one or more identified regions to process the request (e.g., via corresponding LLMs 116 of the remote target agents). The results of the request from the remote target agents 130 are returned to source agent 120.

In addition, source agent 120 may cache matching polytope ranges (or remote target agents 130) received from directory system 140 in response to a query. In this case, source agent 120 may compare the request to the requests in the cache via any conventional or other techniques (e.g., distance, cosine similarity, text matching, etc.). When a match occurs, source agent 120 sends the request to the corresponding remote target agent. Thus, source agent 120 may avoid continually querying directory system 140 for the same or similar requests. The cache may be refreshed based on time periods indicated in the responses from the directory system (e.g., time to live field described below).

Source agent 120 combines the results from the identified agents at operation 340 to produce an overall result for the request that is provided to end-user device 105. For example, the results of the agents may be aggregated, collated, joined, merged, or otherwise combined or formatted to produce the overall result. By way of example, a request may be provided to agents 110 with different specialties that may produce varying information for the request. Source agent 120 extracts the appropriate information (e.g., may ignore duplicate or cumulative information, identify relevant information for the request, etc.) from the agent results via any conventional or other techniques to produce the overall result.

When no agent exists (e.g., no region is identified that contains the embedding of the request, etc.) as determined at operation 310, semantic router 112 of source agent 120 routes or sends the request to a directory system 140 at operation 320. An example embodiment may employ multiple directory systems 140 (e.g., with directory servers 170, etc.), each specializing in a type of request or question set for which that directory system can provide guidance (e.g., the directory systems can assert or advertise their own semantic space or an aggregate polytope boundary encompassing associated polytopes of registered remote target agents). Further, private directory systems (e.g., modified DNS servers, etc.) may be employed which advertise sets of requests or questions (e.g., represented by polytope boundaries) which the private directory system can answer (e.g., the services do not have to be accessible to all, etc.). This provides an ability to bid (or send) a question across a mix of public and private directory systems.

Source agent 120 may determine one or more directory systems 140 to receive the request. This may be accomplished by comparing the request embedding to region boundaries advertised by the directory systems. The source agent may determine the one or more directory systems based on the region boundaries encompassing or being closest to the request embedding in substantially the same manner described above (for selecting remote target agents). Further, the source agent may determine a directory system based on load balancing to provide queries to less loaded directory systems. Source agent 120 may query the directory systems to obtain metrics on their loads.

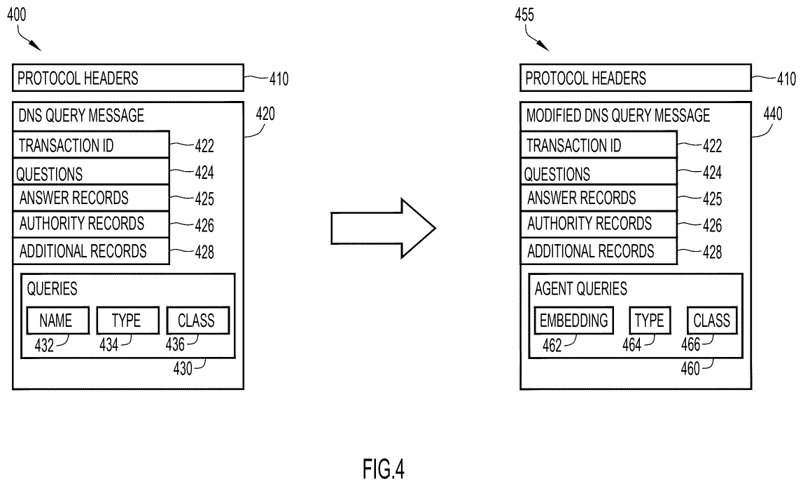

Source agent 120 generates a query for each determined directory system 140 to identify one or more remote target agents 130 capable of handling the request. By way of example, the query may be included within a packet with a modified DNS query message. Referring to FIG. 4, a packet 400 with a conventional DNS query message 420 for resolving URLs to IP addresses includes protocol headers 410, and DNS query message 420. Protocol headers 410 include header information for various communication protocols for routing the packet (e.g., MAC header, IPv4 header, UDP header, etc.).

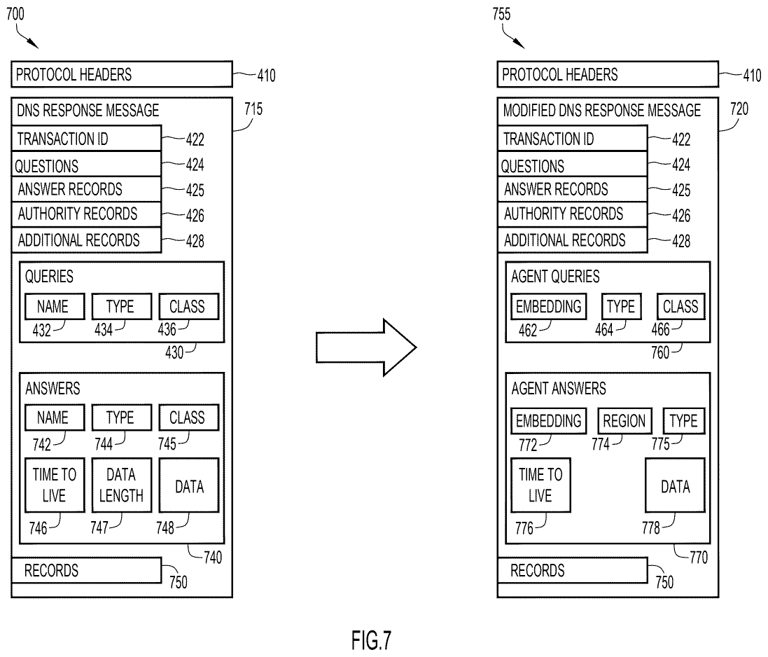

DNS query message 420 includes a transaction ID field 422, a questions field 424, an answer records field 425, an authority records field 426, an additional records field 428, and a queries section 430. Transaction ID field 422 indicates a transaction identification that associates responses with queries, while questions field 424 indicates a quantity of queries within packet 400. Answer records field 425 indicates a quantity of answers in packet 400, authority records field 426 indicates a quantity of (DNS) authority records in packet 400, and additional records field 428 indicates a quantity of additional (DNS) records in packet 400. The answers, authority records, and additional records are typically provided in a response packet as described below (FIG. 7).

Queries section 430 includes the queries for a DNS system to resolve URLs to IP addresses. A query entry includes a name object 432, a type field 434, and a class field 436. Name object 432 indicates a domain name (or URL), while type field 434 indicates a (DNS) record type. Class field 436 indicates names for objects (e.g., INET for Internet, etc.). Packet 400 is provided to a DNS system that resolves the URL and returns a corresponding IP address.

In order for a directory system 140 to identify remote target agents 130 for a request, packet 400 is modified to produce a packet 455. This facilitates a DNS-based protocol that can identify remote target agents 130 instead of, or in addition to, resolving URLs to IP addresses. By way of example, packet 455 includes protocol headers 410 as described above and a modified DNS query message 440. The modified DNS query message includes transaction ID field 422, questions field 424, answer records field 425, authority records field 426, and additional records field 428, each as described above. The answers, authority records, and additional records are typically provided in a modified response packet as described below (FIG. 7).

Modified DNS query message 440 further includes an agent queries section 460 that includes modified objects and fields of queries section 430 for identifying one or more remote target agents 130 for a request. By way of example, agent queries section 460 includes an embedding object 462, a type field 464, and a class field 466. Basically, name object 432 of conventional queries section 430 is replaced by embedding object 462 of agent queries section 460. The embeddings object includes the embedding of a request for identifying one or more remote target agents 130. Type field 464 and class field 466 are similar to type field 434 and class field 436 described above.

Source agent 120 generates and sends packet 455 with the request (or embedding of the request) to a corresponding directory system 140 for processing. In order to accommodate modified packet 455, an allowed size for queries is expanded (e.g., relative to conventional DNS) to accommodate the request embedding. Directory system 140 basically employs a DNS-based protocol that can identify remote target agents 130 instead of, or in addition to, resolving URLs to IP addresses. The directory system (or directory servers 170) analyze received packets 400, 455 and perform the desired functionality (e.g., URL resolution and/or remote target agent identification) based on the objects and fields in the packets. For example, when directory system 140 receives a packet 455 with agent queries section 460, remote target agent identification is performed. The directory system performs URL resolution when a packet 400 is received with queries section 430.

Since directory system 140 preferably has registrations for all or a substantial portion of remote target agents 130 (or for a greater quantity of remote target agents than source agent 120), directory system 140 identifies one or more remote target agents 130 with sufficient skills or capabilities to process the request. The directory system may employ various conventional or other techniques to determine the best/proper embedding vector match between the request embedding and registered or provisioned polytopes, and identify the best remote target agent to handle the request (e.g., the request embedding residing within all polytope ranges, a VectorDB or other search, cosine similarity, principal component analysis to determine which dimensions are relevant for comparison, etc.) as described below.

Once the remote target agents are identified by directory systems 140, source agent 120 receives information (e.g., IP or other network address, agent identity, corresponding polytope, etc.) for the identified remote target agents from directory system 140 at operation 325. The information may be sent in a modified response packet (FIG. 7) as described below. Source agent 120 selects one or more of the identified remote target agents to process the request. For example, multiple answers may be provided from directory system 140 based on a most explicit match to the meaning of the request (e.g., request or question falls in the smallest ranges between low value, high value pairs for dimensions of polytope boundaries, etc.), reputation of the remote target agent in actually answering the question (e.g., based on accuracy, reputation or trustworthiness scores, or other metrics, look-up of reputation from data sources, smaller sized polytope indicating specialized skill range, etc.), and/or monetary costs to answer questions by the remote target agents returned by the directory system). Source agent 120 may select one or more of the identified remote target agents based on configurable parameters (e.g., remote target agent with best match to meaning, reputation of the remote target agent, monetary cost of using the remote target agent, etc.). Source agent 120 may cache responses (e.g., matching polytope ranges and other information for remote target agents 130) received from directory system 140 in order to avoid continually querying directory system 140 for the same or similar requests. The cache may be refreshed based on time periods indicated in the responses from the directory system (e.g., time to live field described below). Further, source agent 120 may update a routing table with the identified remote target agents (e.g., for a duration (or time to live) indicated in the response).

Source agent 120 routes or sends the request to the selected remote target agents 130 based on the information from directory system 140 to process the request (e.g., via corresponding LLMs 116 of the remote target agents) at operation 330. Alternatively, the directory system (or directory servers 170) may route the request to the identified remote target agents 130.

The results of the request from remote target agents 130 are returned to source agent 120. Alternatively, remote target agents 130 may provide the response to directory system 140 for forwarding to source agent 120, when directory system 140 routes the request. Source agent 120 combines the results from the remote target agents at operation 340 to produce an overall result for the request that is provided to end-user device 105 in substantially the same manner described above.

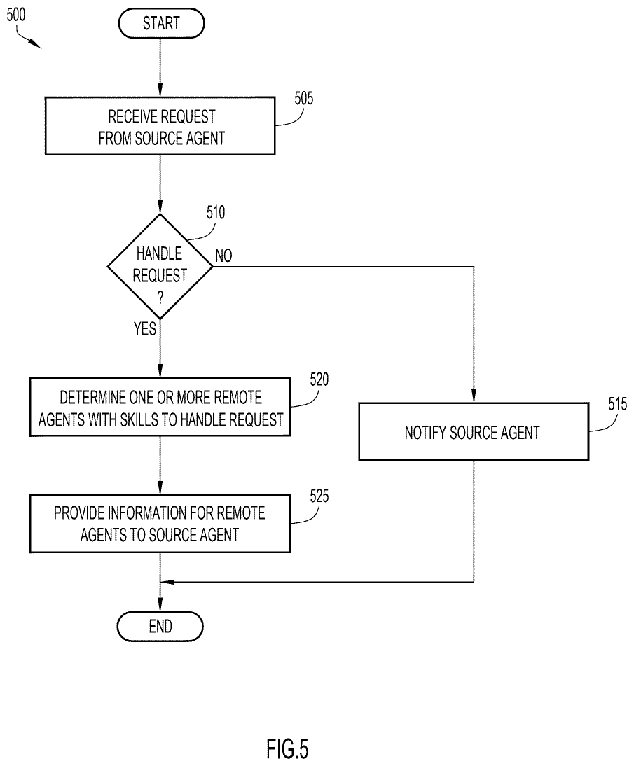

With continued reference to FIG. 1-4, FIG. 5 illustrates a flowchart of a method 500 for determining agents by a directory system to process requests, according to an example embodiment. Initially, a source agent 120 receives a request that the source agent is unable to handle and sends the request (e.g., via a packet 455) to a directory system 140 to determine one or more remote target agents 130 to handle the request in substantially the same manner described above. An embedding for the request may be produced by source agent 120 and sent to directory system 140, or the directory system 140 may receive a text request and generate the embedding for the request.

Directory system 140 receives the request at operation 505. The directory system compares the request embedding to boundaries of regions of remote target agents 130 associated (or registered with) directory system 140. When the request embedding resides outside the regions of remote target agents 130 registered with directory system 140 (e.g., the request cannot be handled by the associated remote target agents) as determined at operation 510, a response indicating the lack of suitable remote target agents 130 to handle the request is provided to source agent 120 at operation 515.

When the request embedding resides within the regions of remote target agents 130 registered with directory system 140 (e.g., the request can be handled by the associated remote target agents) as determined at operation 510, the directory system determines one or more remote target agents 130 to handle the request at operation 520. For example, directory system 140 (or directory server 170) identifies potential regions within the vector space for remote target agents 130 that encompass or contain the embedding of the request. This may be accomplished by comparing the request embedding (corresponding to coordinates in the vector space) to boundaries of the regions corresponding to remote target agents 130 provided during registration. Directory system 140 may employ various conventional or other techniques to determine the best/proper embedding vector match between the request embedding and registered or provisioned regions or polytopes to identify the best remote target agent (e.g., request embedding residing within all polytope ranges, a VectorDB or other search, cosine similarity, principal component analysis to determine which dimensions are relevant for comparison, etc.).

By way of example, the potential regions for remote target agents 130 may be identified when each dimension of the request embedding resides within each range for the dimension of a region or polytope. However, there may be scenarios where the request embedding is contained within more than one region due to overlapping. In this case, a selection technique may be employed to identify an appropriate region and corresponding remote target agent 130. For example, each of the remote target agents associated with the regions containing the request embedding may be selected (e.g., the request may be routed or sent (multicast) to each of those remote target agents). Further, the region having the closest or most explicit match may be selected. This may be determined based on any conventional or other distances of the request embedding to portions of a region (e.g., a request embedding having a greater distance from region boundaries or closer to a region center may represent a closer match, etc.). Moreover, overlapping region segments may be trimmed to resolve ambiguity (or remove the overlap) prior to receipt of the request (e.g., the region with less overlap may be trimmed, etc.).

Further, when no region is identified that encompasses the request, directory system 140 may identify a closest or nearest region to the embedding of the request. This may be determined based on a shortest distance in the vector space between the request embedding and one or more boundaries of the regions using any conventional or other techniques (e.g., Euclidean or other distance metrics, cosine similarity, etc.).

Moreover, a distance (e.g., Euclidean distance, etc.) or cosine similarity value may be determined between the request embedding and region boundaries. The potential regions may be identified when the distance or cosine similarity values satisfy a threshold. In addition, any conventional or other principal component analysis (PCA) may be employed to determine which dimensions of the request embedding and region boundaries should be compared. PCA basically reduces data dimensions while retaining a maximum amount of information. The determined dimensions of the request embedding and region boundaries may be compared in substantially the same manner described above (e.g., request embedding residing within all polytope ranges, a VectorDB or other search, cosine similarity, etc.).

In an example embodiment, directory system 140 may include a hierarchical structure of directory servers 170 (and corresponding remote target agents 130) (e.g., similar to a hierarchical structure of domains and sub-domains in conventional DNS). For example, conventional DNS may employ a recursive DNS server (e.g., operated by a local ISP), a root DNS server corresponding to the period (“.”) of a URL, a top level domain DNS server for top level domains, a second level (or authoritative) DNS server for sub-domains of the top level domain, a third level (or authoritative) DNS server for sub-domains of the second level domains, etc. The hierarchy of DNS servers may be traversed to obtain the IP address for a corresponding URL (from an authoritative server). A fully qualified domain name (FQDN) indicates the precise location in the hierarchy and includes each level of the hierarchy corresponding to the domain name. There may be a hierarchy of sub-domains which eventually resolves to the FQDN. When a DNS record is updated on the authoritative servers, the recursive and local DNS resolvers refresh their caches to reflect the change. This process can take time, depending on the Time-to-Live (TTL) settings of the DNS records, which dictate how long records should be cached. This caching improves the scalability.

In order to resolve a URL to an IP address, a user sends a DNS request to a local recursive DNS server (when the result is not cached). The recursive DNS server determines and sends the DNS request to the appropriate root DNS sever. The root DNS server determines and provides information for the appropriate top level domain DNS server to the recursive DNS server. The top level domain DNS server receives the DNS request from the recursive DNS server and determines and sends information for the appropriate authoritative (DNS) server to the recursive DNS server. The authoritative server receives the DNS request from the recursive DNS server and determines and sends the IP address for the URL to the recursive DNS server. The recursive DNS server forwards the IP address to the user to access a website of the URL.

An example embodiment employs a similar hierarchy of directory servers 170, but each directory server 170 is associated with boundaries of regions for associated remote target agents (instead of URL domains). Remote target agents registered or associated with directory servers of higher levels have greater ranges for boundaries of regions or polytopes (e.g., combined regions of child agents, broader skill set, etc.) and corresponding to broader skills or capabilities, while remote target agents registered or associated with directory servers of lower levels have lesser ranges for bounds of polytopes corresponding to specialized skills or capabilities.

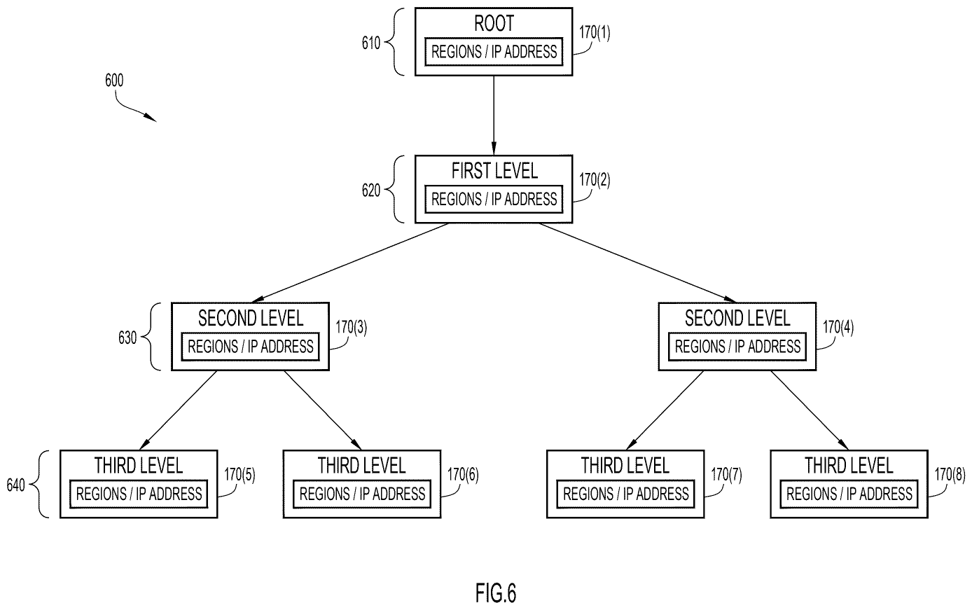

Referring to FIG. 6, an example hierarchical structure 600 for a directory system 140 includes a root level 610, a first level 620, a second level 630, and a third level 640. Root level 610 includes a root directory server 170(1) that receives a request from a source agent 120 (e.g., via a directory server local to the source agent when the result is not cached) and includes region boundaries and corresponding IP addresses for associated remote target agents 130 and the lower level directory servers. The regions for a lower level directory server may be a subset of the regions of the root level directory server and may be an aggregation of regions handled by that lower level directory server. The aggregation may include a range for each dimension of region boundaries, where the range comprises the largest maximum value and lowest minimum value for that dimension from the regions of the lower level directory server. First level 620 includes one or more first level directory servers (e.g., first level directory server 170(2)) that include region boundaries and corresponding IP addresses for associated remote target agents and lower level directory servers. The regions for a lower level directory server are a subset of the regions of the first level directory server and may be an aggregation of regions handled by that lower level directory server (e.g., the largest maximum value and lowest minimum value for each dimension from the regions of the lower level directory server).

Second level 630 includes one or more second level directory servers (e.g., second level directory servers 170(3) and 170(4)) that include region boundaries and corresponding IP addresses for associated remote target agents and lower level directory servers. The regions for a lower level directory server are a subset of the regions of the second level directory server and may be an aggregation of regions handled by that lower level directory server (e.g., the largest maximum value and lowest minimum value for each dimension from the regions of the lower level directory server). Third level 640 includes one or more third level directory servers (e.g., directory servers 170(5) and 170(6) that are children of second level directory server 170(3), and directory servers 170(7) and 170(8) that are children of second level directory server 170(4)). The third level directory servers include region boundaries and corresponding IP addresses for associated remote target agents. However, hierarchical structure 600 may include any quantity of levels with any quantity of directory servers.

Directory system 140 may provide results indicating remote target agents 130 with broader or specialized skills based on the request and/or other parameters. The region boundaries decrease for lower levels of the hierarchical structure, thereby enabling determination of agents highly correlated (or specialized) for responding to a request. For example, root level directory server 170(1) of directory system 140 may receive a request from a source agent 120 (e.g., via the local directory server when the result is not cached). The directory system 140 may traverse hierarchical structure 600 based on comparisons of the request embedding to ranges of directory servers 170 within the levels in order to identify the lowest level (most specialized) remote target agent 130 corresponding to a polytope encompassing the request. The traversal terminates at a hierarchical level when no lower level directory server includes a region boundary encompassing the embedding request. The remote target agent may be identified at the directory server of that level.

By way of example, the request may be provided from the local directory server to root level directory server 170(1), first level directory server 170(2), second level directory server 170(3), and third level directory server 170(6) based on comparisons of the request embedding to region boundaries of those directory servers. The remote target agent registered with third level directory server 170(6) and associated with a region encompassing the embedding request may be identified and the corresponding IP address and other information returned. Since the region boundaries (or differences between ranges for region dimensions) decrease with lower levels of the hierarchical structure, the resulting remote target agent should be highly specialized to process the request. Directory system 140 may hide or restrict access to lower level agents by providing the higher level agents to handle the request. When a record is updated on a lower level directory server, caches of other directory servers are refreshed to reflect the change. This process can take time, depending on the Time-to-Live (TTL) settings of the records, which dictate how long records should be cached. This caching improves the scalability.

The hierarchical structure enables distribution of management of directory servers 170 and/or remote target agents 130. For example, a directory server 170 may update IP addresses and/or regions of other directory servers and/or remote target agents registered with that directory server. This may be used to switch directory servers and/or remote target agents in the event of a device or network failure. Further, the hierarchical structure enables requests or questions to be handled by remote target agents of certain entities. The entity may be considered when generating the embeddings (of the intents and contexts) and the resulting region or polytope for a remote target agent. Thus, remote target agents of an entity reside in a similar locale in the semantic vector space, and enable the same or similar request or question applicable to different entities to be directed to a remote target agent of a specific entity. For example, a request may include a general inquiry about a product of a certain entity. The hierarchical structure enables the request to be directed to a remote target agent of the entity providing the product corresponding to the request based on the boundaries of the regions of the directory servers.

In addition, multiple answers may be provided for a directory system query based on configurable parameters (e.g., request or question falls in the smallest ranges between low value, high value pairs for dimensions of polytope boundaries, etc.), reputation of the remote target agent in actually answering the question (e.g., based on accuracy, reputation or trustworthiness scores, or other metrics, etc.), monetary costs to answer questions by the remote target agents, etc.).

Hierarchical structure 600 may be global (or have a single authoritative owner). However, an embodiment may have plural parallel hierarchical structures 600 each associated with a different organizational or other entity, subject matter expertise, etc. For example, there may be hierarchical structures 600 local to (or configured to accommodate requests from) corresponding source agents (or users). Further, a source agent (or local directory server) may determine which hierarchical structure to utilize based on a comparison of a request embedding to embedding ranges of skills or capabilities for the remote agents associated with the hierarchical structures. The request may be processed to traverse the determined hierarchical structure in substantially the same manner described above to determine a remote agent.

Conventional DNS systems may have a hierarchy of sub-domains which eventually resolve to an FQDN. However, an embodiment may not have a hierarchy of sub-domains. In this case, the polytope boundaries of a second level directory server may be resolved. Further, lower level directory servers of the hierarchical structure can be hidden and not exposed to the user. This allows sub-regions of polytopes to be hidden which may be serviced behind a remote agent at an intermediate level. This allows targeting an intermediate directory server rather than a definitive directory server at the bottom of the hierarchical structure. An embodiment may determine or select the specific level (or directory server) of the hierarchical structure to provide the response (or remote agent) based on various criteria (e.g., the request, the user/source agent providing the request, etc.). The selected level may be any (e.g., upper, intermediate, or lowest) level of the hierarchical structure.

Once the remote target agents are identified by directory system 140, the directory system sends information (e.g., IP or other network address, agent identity, corresponding polytope, etc.) for the identified remote target agents to source agent 120 at operation 525. The information may be sent in a modified response packet (FIG. 7) as described below. Directory system 140 generates a response for the request indicating the one or more remote target agents 130 capable of handling the request.

By way of example, the response may be included within a packet with a modified DNS response message. Referring to FIG. 7, a packet 700 with a conventional DNS response message 715 for resolving URLs to IP addresses includes protocol headers 410, and DNS response message 715. Protocol headers 410 include header information for various communication protocols as described above. DNS response message 715 includes transaction ID field 422, questions field 424, answer records field 425, authority records field 426, and additional records field 428, each as described above. The DNS response message further includes queries section 430, an answers section 740, and a records section 750. Queries section 430 is as described above with name object 432, type field 434 and class field 436. Queries section 430 includes the queries for a DNS system to resolve URLs to IP addresses as described above, and corresponds to the answers in answers section 740.

Answers section 740 includes the responses to the queries in queries section 430. The answers section includes a name object 742, a type field 744, a class field 745, a time to live field 746, a data length field 747, and a data field 748. Name object 742, type field 744, and class field 745 are substantially similar to the corresponding objects and fields in queries section 430. Time to live field 746 indicates a time interval (e.g., seconds, etc.) for viability of the answer. Data length field 747 indicates a length of data returned, while data field 748 indicates information for the response (e.g., an IP address, etc.).

Records section 750 includes the (DNS) authority records, and additional (DNS) records for the response.

In order for a directory system 140 to provide information pertaining to remote target agents 130 for a request, packet 700 is modified to produce a packet 755. This facilitates the DNS-based protocol that can identify remote target agents 130 instead of, or in addition to, resolving URLs to IP addresses. By way of example, packet 755 includes protocol headers 410 as described above and a modified DNS response message 720. The modified DNS response message includes transaction ID field 422, questions field 424, answer records field 425, authority records field 426, additional records field 428, and records section 750, each as described above.

Modified DNS response message 720 further includes an agent queries section 760 that is substantially similar to agent queries section 460 described above. By way of example, agent queries section 760 includes embedding object 462, type field 464, and class field 466, each as described above. Basically, name object 432 of conventional queries section 430 is replaced by embedding object 462 of agent queries section 460. The embeddings object includes the embedding of a request for identifying one or more remote target agents 130.

Modified DNS response message 720 further includes an agent answers section 770 that includes modified objects and fields of answers section 740 for providing information for one or more remote target agents 130 for a request (as opposed to conventional DNS providing IP addresses for URLs). By way of example, agent answers section 770 includes an embedding object 772, a region object 774, a type field 775, a time to live field 776, and a data field 778. Basically, name object 742 and data length field 747 of conventional answers section 740 is replaced by embedding object 772 and region object 774 in agent answers section 770. The embedding object includes the embedding of a request for identifying one or more remote target agents 130. Region object 774 includes the region (or polytope) boundaries of the remote target agent 130 identified for the request. Type field 775 and time to live field 776 are substantially similar to the corresponding fields in answers section 740. Data field 778 indicates information for the identified remote target agent (e.g., an IP address, etc.).

Directory system 140 generates and sends packet 755 to source agent 120 in response to the request for routing the request to the identified remote target agents 130. The source agent extracts the information for remote target agents 130 from packet 755 to route the request to one or more of the remote target agents. Directory system 140 basically employs a DNS-based protocol that can identify remote target agents 130 instead of, or in addition to, resolving URLs to IP addresses. The directory system (or directory servers 170) analyze received packets 400, 455 and perform the desired functionality (e.g., URL resolution and/or remote target agent identification) based on the objects and fields in the packets. For example, when directory system 140 receives a packet 455 with agent queries section 460, remote target agent identification is performed and the directory system generates packet 755 for the response. The directory system performs URL resolution and generates packet 700 for the response when a packet 400 is received with queries section 430.

Alternatively, directory system 140 may route the requests to the determined remote target agents 130, and forward results from the remote target agents to source agent 120.

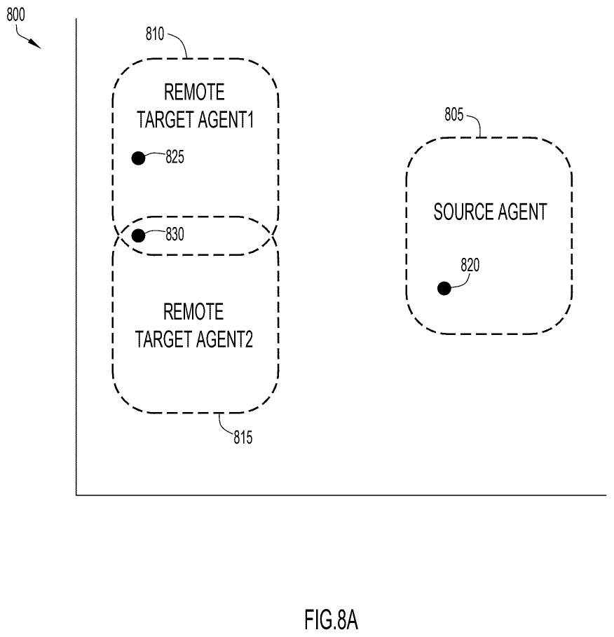

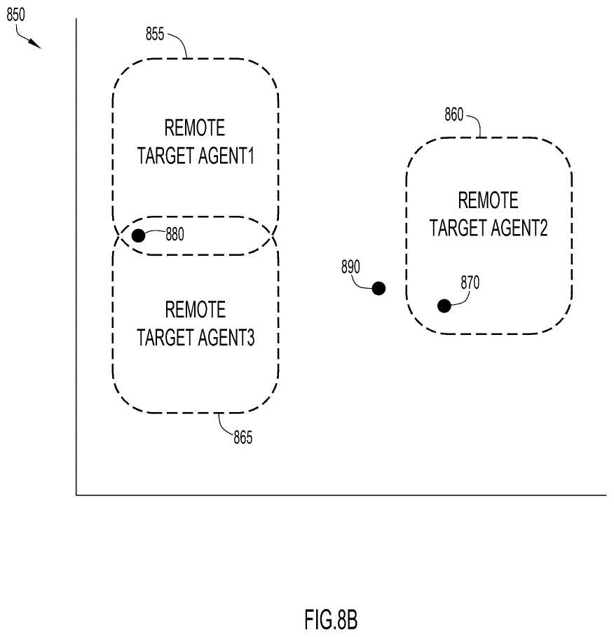

With continued reference to FIGS. 1-7, FIG. 8A illustrates an example vector space 800 for a source agent 120 for determining agents to process requests, according to an example embodiment. Initially, vector space 800 includes dimensions corresponding to the dimensions of embeddings of requests and agent intents and contexts. The collective (intent, context) embeddings of source agent 120 (e.g., SOURCE AGENT as viewed in FIG. 8A) and each remote target agent 130 (e.g., REMOTE TARGET AGENT1 and REMOTE TARGET AGENT2 as viewed in FIG. 8A) occupy a corresponding discrete region in the vector space. By way of example, vector space 800 includes a region 805 corresponding to source agent 120, a region 810 corresponding to REMOTE TARGET AGENT1 registered with source agent 120, and a region 815 corresponding to REMOTE TARGET AGENT2 registered with source agent 120. Accordingly, each region 805, 810, 815 defines the entire set of skills or capabilities (e.g., intents, contexts, etc.) for the corresponding agent and, thus, represents the boundary of the agent skills or capabilities. However, the vector space may include any quantity of regions for any quantity of agents 110.

Source agent 120 may receive a request and determine an embedding 820 of the request (intent and context) mapped to vector space 800 in substantially the same manner described above. Semantic router 112 of source agent 120 identifies region 805 that encompasses or contains embedding 820 of the request (based on a comparison of the request embedding to boundaries of regions 810, 815 of vector space 800 provided during registration and to boundaries of region 805 known to the source agent) in substantially the same manner described above. Since region 805 corresponds to source agent 120, the source agent may process the request to produce results in substantially the same manner described above.

Source agent 120 may receive another request and determine an embedding 825 of the request (intent and context) mapped to vector space 800 in substantially the same manner described above. Semantic router 112 of the source agent identifies region 810 that encompasses or contains embedding 825 of the request (based on a comparison of the request embedding to boundaries of regions 810, 815 of vector space 800 provided during registration and to boundaries of region 805 known to the source agent). Since region 810 corresponds to REMOTE TARGET AGENT1, semantic router 112 of source agent 120 directly routes or sends the request to REMOTE TARGET AGENT1 to process the request (e.g., via corresponding LLM 116) in substantially the same manner described above. The results of the request from REMOTE TARGET AGENT1 are returned to source agent 120 to provide results for the request in substantially the same manner described above.

Source agent 120 may receive yet another request and determine an embedding 830 of the request (intent and context) mapped to vector space 800 in substantially the same manner described above. Semantic router 112 of source agent 120 identifies regions 810 and 815 that each encompass or contain embedding 830 of the request (based on a comparison of the request embedding to boundaries of regions 810, 815 of vector space 800 provided during registration and to boundaries of region 805 known to the source agent) in substantially the same manner described above. Since regions 810, 815 correspond to REMOTE TARGET AGENT1 and REMOTE TARGET AGENT2, semantic router 112 of source agent 120 directly routes or sends the request to REMOTE TARGET AGENT1 and REMOTE TARGET AGENT2 to process the request (e.g., via corresponding LLMs 116) in substantially the same manner described above. The results of the request from REMOTE TARGET AGENT1 and REMOTE TARGET AGENT2 are returned to source agent 120 to provide results for the request in substantially the same manner described above.

In the event that the embedding of a request resides outside the regions of vector space 800 (e.g., corresponding to source agent 120 and remote target agents 130 registered with the source agent), the request is routed or sent by semantic router 112 of source agent 120 to a directory system 140. Since directory system 140 preferably has registrations for all or a substantial portion of remote target agents 130 (or for a greater quantity of remote target agents than source agent 120), directory system 140 identifies one or more remote target agents 130 to process the request. With continued reference to FIGS. 1-7 and 8A , FIG. 8B illustrates an example vector space 850 for directory system 140 for determining agents to process requests, according to an example embodiment. Initially, vector space 850 includes dimensions corresponding to the dimensions of embeddings of requests and agent intents and contexts. The collective (intent, context) embeddings of each remote target agent 130 (e.g., REMOTE TARGET AGENT1, REMOTE TARGET AGENT2, and REMOTE TARGET AGENT3 as viewed in FIG. 8B) occupy a corresponding discrete region in the vector space. By way of example, vector space 850 includes a region 855 corresponding to REMOTE TARGET AGENT1, a region 860 corresponding to REMOTE TARGET AGENT2, and a region 865 corresponding to REMOTE TARGET AGENT3. Accordingly, each region 855, 860, 865 defines the entire set of skills or capabilities (e.g., intents, contexts, etc.) for the corresponding agent and, thus, represents the boundary of the agent skills or capabilities. However, the vector space may include any quantity of regions for any quantity of agents 110.

Directory system 140 may receive a request from source agent 120 and determine an embedding 870 of the request (intent and context) mapped to vector space 850 in substantially the same manner described above. Alternatively, the directory system may receive embedding 870 from source agent 120 in substantially the same manner described above. Directory system 140 identifies region 860 that encompasses or contains embedding 870 of the request (based on a comparison of the request embedding to boundaries of the regions of vector space 850 provided during registration) in substantially the same manner described above. Since region 860 corresponds to REMOTE TARGET AGENT2, directory system 140 sends information for REMOTE TARGET AGENT2 to source agent 120. The source agent routes the request to REMOTE TARGET AGENT2 to process the request (e.g., via corresponding LLM 116) in substantially the same manner described above. The results of the request from REMOTE TARGET AGENT2 are returned to source agent 120 to produce results for the request in substantially the same manner described above.

Directory system 140 may receive another request from source agent 120 and determine an embedding 880 of the request (intent and context) mapped to vector space 850 in substantially the same manner described above. Alternatively, directory system 140 may receive embedding 880 from source agent 120 in substantially the same manner described above. The directory system identifies regions 855 and 865 that each encompass or contain embedding 880 of the request (based on a comparison of the request embedding to boundaries of the regions of vector space 850 provided during registration) in substantially the same manner described above. Since regions 855, 865 correspond to REMOTE TARGET AGENT1 and REMOTE TARGET AGENT3, directory system 140 sends information for these remote target agents to source agent 120. The source agent routes the request to REMOTE TARGET AGENT1 and REMOTE TARGET AGENT3 to process the request (e.g., via corresponding LLMs 116) in substantially the same manner described above. The results of the request from REMOTE TARGET AGENT1 and REMOTE TARGET AGENT3 are returned to source agent 120 to produce results for the request in substantially the same manner described above.

Directory system 140 may receive yet another request from source agent 120 and determine an embedding 890 of the request (intent and context) mapped to vector space 850 in substantially the same manner described above. Alternatively, directory system 140 may receive embedding 890 from source agent 120 in substantially the same manner described above. Since embedding 890 resides outside regions 855, 860, 865 of vector space 850, directory system 140 is unable to initially identify a remote target agent to process the request (based on a comparison of the request embedding to boundaries of the regions of vector space 850 provided during registration). In this case, directory system 140 identifies a closest or nearest region to embedding 890. This may be determined based on a shortest distance in vector space 850 between embedding 890 and one or more boundaries of regions 855, 860, 865 using any conventional or other techniques (e.g., Euclidean or other distance metrics, cosine similarity, etc.) in substantially the same manner described above.

By way of example, embedding 890 may be closest to region 860 (e.g., as viewed in FIG. 8B). Since region 860 corresponds to REMOTE TARGET AGENT2, directory system 140 sends information for REMOTE TARGET AGENT2 to source agent 120. The source agent routes the request to REMOTE TARGET AGENT2 to process the request (e.g., via corresponding LLM 116) in substantially the same manner described above. The results of the request from REMOTE TARGET AGENT2 are returned to source agent 120 to produce results for the request in substantially the same manner described above.

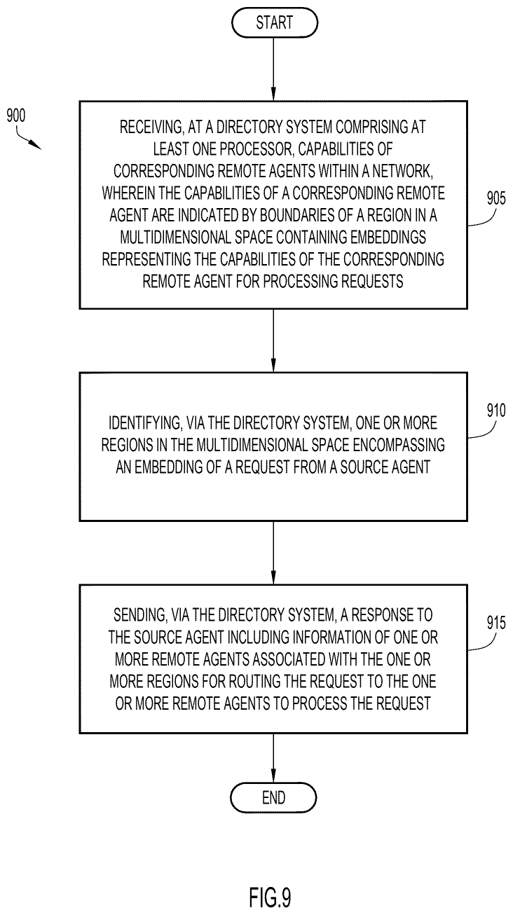

FIG. 9 is a flowchart of an example method 900 for routing requests to corresponding agents, according to an example embodiment. At operation 905, a directory system comprising at least one processor receives capabilities of corresponding remote agents within a network. The capabilities of a corresponding remote agent are indicated by boundaries of a region in a multidimensional space containing embeddings representing the capabilities of the corresponding remote agent for processing requests. At operation 910, the directory system identifies one or more regions in the multidimensional space encompassing an embedding of a request from a source agent. At operation 915, the directory system sends a response to the source agent including information of one or more remote agents associated with the one or more regions for routing the request to the one or more remote agents to process the request.

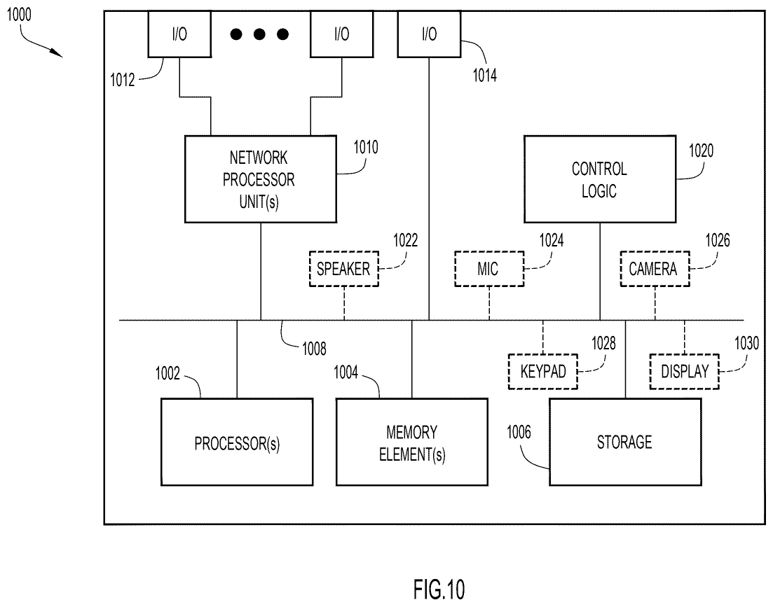

Referring to FIG. 10, FIG. 10 illustrates a hardware block diagram of a computing device 1000 that may perform functions associated with operations discussed herein in connection with the techniques depicted in FIG. 1-9. In various embodiments, a computing device or apparatus or system, such as computing device 1000 or any combination of computing devices 1000, may be configured as any device entity/entities (e.g., network nodes, computer devices, end-user devices, directory or other servers, client devices, communication devices, network devices, processors, switching devices, network interfaces, agents, routers, directory systems, etc.) as discussed for the techniques depicted in connection with FIG. 1-9 in order to perform operations of the various techniques discussed herein.

In at least one embodiment, computing device 1000 may be any apparatus that may include one or more processor(s) 1002, one or more memory element(s) 1004, storage 1006, a bus 1008, one or more network processor unit(s) 1010 interconnected with one or more network input/output (I/O) interface(s) 1012, one or more I/O interface(s) 1014, and control logic 1020. In various embodiments, instructions associated with logic for computing device 1000 can overlap in any manner and are not limited to the specific allocation of instructions and/or operations described herein.

In at least one embodiment, processor(s) 1002 is/are at least one hardware processor configured to execute various tasks, operations and/or functions for computing device 1000 as described herein according to software and/or instructions configured for computing device 1000. Processor(s) 1002 (e.g., a hardware processor) can execute any type of instructions associated with data to achieve the operations detailed herein. In one example, processor(s) 1002 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1004 and/or storage 1006 is/are configured to store data, information, software, and/or instructions associated with computing device 1000, and/or logic configured for memory element(s) 1004 and/or storage 1006. For example, any logic described herein (e.g., control logic 1020) can, in various embodiments, be stored for computing device 1000 using any combination of memory element(s) 1004 and/or storage 1006. Note that in some embodiments, storage 1006 can be consolidated with memory elements 1004 (or vice versa), or can overlap/exist in any other suitable manner.

In at least one embodiment, bus 1008 can be configured as an interface that enables one or more elements of computing device 1000 to communicate in order to exchange information and/or data. Bus 1008 can be implemented with any architecture designed for passing control, data and/or information between processors, memory elements/storage, peripheral devices, and/or any other hardware and/or software components that may be configured for computing device 1000. In at least one embodiment, bus 1008 may be implemented as a fast kernel-hosted interconnect, potentially using shared memory between processes (e.g., logic), which can enable efficient communication paths between the processes.

In various embodiments, network processor unit(s) 1010 may enable communication between computing device 1000 and other systems, entities, etc., via network I/O interface(s) 1012 to facilitate operations discussed for various embodiments described herein. In various embodiments, network processor unit(s) 1010 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1000 and other systems, entities, etc. to facilitate operations for various embodiments described herein. In various embodiments, network I/O interface(s) 1012 can be configured as one or more Ethernet port(s), Fibre Channel ports, any other I/O port(s), and/or antenna(s)/antenna array(s) now known or hereafter developed. Thus, the network processor unit(s) 1010 and/or network I/O interfaces 1012 may include suitable interfaces for receiving, transmitting, and/or otherwise communicating data and/or information in a network environment.

I/O interface(s) 1014 allow for input and output of data and/or information with other entities that may be connected to computing device 1000. For example, I/O interface(s) 1014 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

With respect to certain entities (e.g., client device, end-user device, network device, network nodes, processors, network interfaces, switching devices, agents, servers, routers, etc.), computing device 1000 may further include, or be coupled to, a speaker 1022 to convey sound, microphone or other sound sensing device 1024, camera or image capture device 1026, a keypad or keyboard 1028 to enter information (e.g., alphanumeric information, etc.), and/or a touch screen or other display 1030. These items may be coupled to bus 1008 or I/O interface(s) 1014 to transfer data with other elements of computing device 1000.

In various embodiments, control logic 1020 can include instructions that, when executed, cause processor(s) 1002 to perform operations, which can include, but not be limited to, providing overall control operations of computing device 1000; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

Present embodiments may provide various technical and other advantages. In an embodiment, network routing is performed to direct a request to appropriate agents for processing based on semantic correlation of a request intent to agent skills or capabilities which increases throughput and performance for handling requests and avoids re-routing and re-processing of requests. This also reduces consumption of processing and memory/storage resources to improve computing performance and network routing.

In an embodiment, the machine learning models (and/or LLM prompts) may be continuously updated (or trained) based on feedback related to results of the agents. For example, an agent may return a poor result (e.g., based on various metrics, etc.). The feedback may be used to update or train the machine learning models (or LLM prompts) to decrease the confidence of that response, and/or to avoid routing to that agent for similar requests. A similar approach may be used for a good result, where the feedback may be used to update or train the machine learning models (or LLM prompts) to increase the confidence of that response, and/or increase routing to that agent for similar requests. Thus, the machine learning models (or LLM prompts) may continuously evolve (or be trained) to learn to produce appropriate responses, and/or routing may be updated as requests are processed.

The programs described herein (e.g., control logic 1020) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other stores or repositories, queue, etc.). The data transmitted between device entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., graphical user interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, network devices, storage devices, etc.) and databases or other repositories arranged in any desired fashion, where the present embodiments may be applied to any desired type of computing environment (e.g., cloud computing, client-server, network computing, mainframe, stand-alone systems, datacenters, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software. These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flowcharts and diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various network devices, storage devices, and other processing devices or systems, and/or any other intermediary processing devices. The software and/or algorithms described above and illustrated in the flowcharts and diagrams may be modified in any manner that accomplishes the functions described herein. In addition, the functions in the flowcharts, diagrams, or description may be performed in any order that accomplishes a desired operation.

The networks of present embodiments may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., LAN, hardwire, wireless link, Intranet, etc.).

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

In various embodiments, any device entity or apparatus as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more device entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 1004 and/or storage 1006 can store data, software, code, instructions (e.g., processor instructions), logic, parameters, combinations thereof, and/or the like used for operations described herein. This includes memory elements 1004 and/or storage 1006 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any device entity or apparatus for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four device entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ or ‘frame’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more device entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combinations of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In one form, a method is provided. The method comprises: receiving, at a directory system comprising at least one processor, capabilities of corresponding remote agents within a network, wherein the capabilities of a corresponding remote agent are indicated by boundaries of a region in a multidimensional space containing embeddings representing the capabilities of the corresponding remote agent for processing requests; identifying, via the directory system, one or more regions in the multidimensional space encompassing an embedding of a request from a source agent; and sending, via the directory system, a response to the source agent including information of one or more remote agents associated with the one or more regions for routing the request to the one or more remote agents to process the request.

In one example, the corresponding remote agents include artificial intelligence agents and the region for the corresponding remote agent is defined by a set of embeddings of intents and contexts for the corresponding remote agent, wherein the set of embeddings includes ranges for each dimension, and wherein the one or more regions are identified based on dimensions of the embedding of the request being within the ranges of the set of embeddings for the one or more regions.

In one example, the directory system includes one or more servers implementing a Domain Name System (DNS)-based protocol.

In one example, the request includes a DNS query message modified to include the embedding of the request, and the response includes a DNS response message modified to include the information for the one or more remote agents.

In one example, the directory system includes a plurality of servers implementing the Domain Name System (DNS)-based protocol and arranged in a hierarchical structure, wherein remote agents associated with servers at higher levels of the hierarchical structure have greater ranges for region boundaries corresponding to broader capabilities and remote agents associated with servers at lower levels of the hierarchical structure have lesser ranges for region boundaries corresponding to specialized capabilities.

In one example, the directory system is local to the source agent, and identifying one or more regions in the multidimensional space comprises traversing the hierarchical structure of the plurality of servers to identify a server at a selected level in the hierarchical structure and associated with a remote agent having a region in the multidimensional space encompassing the embedding of the request.

In one example, the method further comprises receiving the request, via the directory system, when the source agent is unable to identify at least one remote agent to process the request.

In another form, an apparatus is provided. The apparatus comprises a network interface configured to enable communications in a network; a memory; and at least one processor coupled to the network interface and the memory, the at least one processor configured to perform operations including: receiving capabilities of corresponding remote agents within a network, wherein the capabilities of a corresponding remote agent are indicated by boundaries of a region in a multidimensional space containing embeddings representing the capabilities of the corresponding remote agent for processing requests; identifying one or more regions in the multidimensional space encompassing an embedding of a request from a source agent; and sending a response to the source agent including information of one or more remote agents associated with the one or more regions for routing the request to the one or more remote agents to process the request.

In another form, one or more non-transitory computer readable storage media are provided. The one or more non-transitory computer readable storage media are encoded with processing instructions that, when executed by one or more processors of a directory system, cause the one or more processors to perform operations including: receiving capabilities of corresponding remote agents within a network, wherein the capabilities of a corresponding remote agent are indicated by boundaries of a region in a multidimensional space containing embeddings representing the capabilities of the corresponding remote agent for processing requests; identifying one or more regions in the multidimensional space encompassing an embedding of a request from a source agent; and sending a response to the source agent including information of one or more remote agents associated with the one or more regions for routing the request to the one or more remote agents to process the request.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
receiving, at a directory system comprising at least one processor, capabilities of corresponding remote agents within a network, wherein the capabilities of a corresponding remote agent are indicated by boundaries of a region in a multidimensional space containing embeddings representing the capabilities of the corresponding remote agent for processing requests;
identifying, via the directory system, one or more regions in the multidimensional space encompassing an embedding of a request from a source agent; and
sending, via the directory system, a response to the source agent including information of one or more remote agents associated with the one or more regions for routing the request to the one or more remote agents to process the request.

2. The method of claim 1, wherein the corresponding remote agents include artificial intelligence agents and the region for the corresponding remote agent is defined by a set of embeddings of intents and contexts for the corresponding remote agent, wherein the set of embeddings includes ranges for each dimension, and wherein the one or more regions are identified based on dimensions of the embedding of the request being within the ranges of the set of embeddings for the one or more regions.

3. The method of claim 1, wherein the directory system includes one or more servers implementing a Domain Name System (DNS)-based protocol.

4. The method of claim 3, wherein the request includes a DNS query message modified to include the embedding of the request, and the response includes a DNS response message modified to include the information for the one or more remote agents.

5. The method of claim 3, wherein the directory system includes a plurality of servers implementing the Domain Name System (DNS)-based protocol and arranged in a hierarchical structure, wherein remote agents associated with servers at higher levels of the hierarchical structure have greater ranges for region boundaries corresponding to broader capabilities and remote agents associated with servers at lower levels of the hierarchical structure have lesser ranges for region boundaries corresponding to specialized capabilities.

6. The method of claim 5, wherein the directory system is local to the source agent, and identifying one or more regions in the multidimensional space comprises:
traversing the hierarchical structure of the plurality of servers to identify a server at a selected level in the hierarchical structure and associated with a remote agent having a region in the multidimensional space encompassing the embedding of the request.

7. The method of claim 1, further comprising:
receiving the request, via the directory system, when the source agent is unable to identify at least one remote agent to process the request.

8. An apparatus comprising:
a network interface configured to enable communications in a network;
a memory; and
at least one processor coupled to the network interface and the memory, the at least one processor configured to perform operations for a directory system, the operations including:
receiving capabilities of corresponding remote agents within the network, wherein the capabilities of a corresponding remote agent are indicated by boundaries of a region in a multidimensional space containing embeddings representing the capabilities of the corresponding remote agent for processing requests;
identifying one or more regions in the multidimensional space encompassing an embedding of a request from a source agent; and
sending a response to the source agent including information of one or more remote agents associated with the one or more regions for routing the request to the one or more remote agents to process the request.

9. The apparatus of claim 8, wherein the corresponding remote agents include artificial intelligence agents and the region for the corresponding remote agent is defined by a set of embeddings of intents and contexts for the corresponding remote agent, wherein the set of embeddings includes ranges for each dimension, and wherein the one or more regions are identified based on dimensions of the embedding of the request being within the ranges of the set of embeddings for the one or more regions.

10. The apparatus of claim 8, wherein the directory system includes one or more servers implementing a Domain Name System (DNS)-based protocol.

11. The apparatus of claim 10, wherein the request includes a DNS query message modified to include the embedding of the request, and the response includes a DNS response message modified to include the information for the one or more remote agents.

12. The apparatus of claim 10, wherein the directory system includes a plurality of servers implementing the Domain Name System (DNS)-based protocol and arranged in a hierarchical structure, wherein remote agents associated with servers at higher levels of the hierarchical structure have greater ranges for region boundaries corresponding to broader capabilities and remote agents associated with servers at lower levels of the hierarchical structure have lesser ranges for region boundaries corresponding to specialized capabilities.

13. The apparatus of claim 12, wherein the directory system is local to the source agent, and identifying one or more regions in the multidimensional space comprises:
traversing the hierarchical structure of the plurality of servers to identify a server at a selected level in the hierarchical structure and associated with a remote agent having a region in the multidimensional space encompassing the embedding of the request.

14. One or more non-transitory computer readable storage media encoded with processing instructions that, when executed by one or more processors of a directory system, cause the one or more processors to perform operations including:
receiving capabilities of corresponding remote agents within a network, wherein the capabilities of a corresponding remote agent are indicated by boundaries of a region in a multidimensional space containing embeddings representing the capabilities of the corresponding remote agent for processing requests;
identifying one or more regions in the multidimensional space encompassing an embedding of a request from a source agent; and
sending a response to the source agent including information of one or more remote agents associated with the one or more regions for routing the request to the one or more remote agents to process the request.

15. The one or more non-transitory computer readable storage media of claim 14, wherein the corresponding remote agents include artificial intelligence agents and the region for the corresponding remote agent is defined by a set of embeddings of intents and contexts for the corresponding remote agent, wherein the set of embeddings includes ranges for each dimension, and wherein the one or more regions are identified based on dimensions of the embedding of the request being within the ranges of the set of embeddings for the one or more regions.

16. The one or more non-transitory computer readable storage media of claim 14, wherein the directory system includes one or more servers implementing a Domain Name System (DNS)-based protocol.

17. The one or more non-transitory computer readable storage media of claim 16, wherein the request includes a DNS query message modified to include the embedding of the request, and the response includes a DNS response message modified to include the information for the one or more remote agents.

18. The one or more non-transitory computer readable storage media of claim 16, wherein the directory system includes a plurality of servers implementing the Domain Name System (DNS)-based protocol and arranged in a hierarchical structure, wherein remote agents associated with servers at higher levels of the hierarchical structure have greater ranges for region boundaries corresponding to broader capabilities and remote agents associated with servers at lower levels of the hierarchical structure have lesser ranges for region boundaries corresponding to specialized capabilities.

19. The one or more non-transitory computer readable storage media of claim 18, wherein the directory system is local to the source agent, and identifying one or more regions in the multidimensional space comprises:
traversing the hierarchical structure of the plurality of servers to identify a server at a selected level in the hierarchical structure and associated with a remote agent having a region in the multidimensional space encompassing the embedding of the request.

20. The one or more non-transitory computer readable storage media of claim 14, wherein the processing instructions further cause the one or more processors to perform operations including:
receiving the request when the source agent is unable to identify at least one remote agent to process the request.
